(19) United States
(12) Patent Application Publication
(10) Pub. No.: US 2022/0410540 A1
(43) Pub. Date: Dec. 29, 2022

(54) LAMINATED GLAZING

(71) Applicant: AGC GLASS EUROPE, Louvain-la-Neuve (BE)

(72) Inventors: Rolf GERVELMEYER, Geilenkirchen (DE); Kadosa HEVESI, Namur (BE)

(73) Assignee: AGC GLASS EUROPE, Louvain-la-Neuve (BE)

(21) Appl. No.: 17/776,924

(22) PCT Filed: Nov. 16, 2020
(86) PCT No.: PCT/EP2020/082210

§ 371 Date: May 13, 2022

(30) Foreign Application Priority Data
Nov. 18, 2019 (EP) 19209800.2

(51) Int. Cl. B32B 17/10; B32B 15/02; B32B 17/06; B32B 3/02; B32B 3/10; H05B 3/86

(52) U.S. Cl. CPC B32B 17/10385; B32B 15/02; B32B 17/10036; B32B 17/061; B32B 17/10807; B32B 3/02; B32B 17/10449; B32B 17/10128; B32B 3/10; H05B 3/86; H05B 2203/007; B32B 2250/40; B32B 2307/202; B32B 2307/412; B32B 2307/42; B32B 2307/732; B32B 2255/28; B32B 2255/06; B32B 2605/006

(57) ABSTRACT

A laminated glazing usable as a heatable glazing for means of transportation. Also, a method for producing the laminated glazing and a method for decreasing the sheet resistance of the laminated glazing.

### FIELD OF THE INVENTION

The present invention relates to a laminated glazing, to a method for producing said laminated glazing and to a method for decreasing sheet resistance of a laminated glazing. The present invention also relates to the use of said laminated glazing as a heatable glazing for means of transportation.

### BACKGROUND OF THE INVENTION

Electrically heatable laminated glazing with heating circuits and bus bars in electrical contact therewith are known in numerous different constructions. Heating circuits include conductive coatings on the glass or on polymeric substrates, wire resistive heated circuits, micro lithographic conductors, embedded wire circuit, among others. The heating of a laminated glazing may typically serve defrosting or de-icing purposes.

Solar control glazing are also known in a wide variety of constructions and lay outs. Such solar control glazing typically assist in managing the light and thermal exchanges between the interior of a vehicle or building, and the exterior, that is, they typically provide for a function of thermal insulation, by virtue, for example, of solar control coatings applied on the glass.

In some instances, such solar control coatings comprise at least one layer of conductive material, which can function as heating circuit in laminated glazings.

Wire resistive heated circuits are typically based on wires having thicknesses of from 10 to 100 μm, that is, in a similar range as the thickness of a human hair fiber, of 40 to 120 μm. Examples include tungsten wires of 15-25 μm thickness, or cupper wires of 60-90 μm. Although some of these wires may be positioned in viewing areas of laminated glazings, they still may be perceived by the human eye.

In transportation applications, solar control glazings may reduce the need for air-conditioning requirements by blocking infrared radiations from entering the vehicle, while they can also assist in reducing heat loss to the exterior, when the inside of the vehicle is heated.

The heat regulation systems in transportation and building applications require a lot of energy. The rise of electrically powered vehicles requires optimal use of the available electric power to efficiently and rapidly focus on the various functions of said vehicles. The driving energy is, for the most part, carried along in the motor vehicle in the form of chargeable accumulators and rechargeable batteries or generated in the motor vehicle itself by fuel cells. An electric motor converts the electrical energy into mechanical energy for locomotion. The onboard voltage of electric vehicles is typically from 12 V to 400 V. Because of the limited energy storage density of accumulators or rechargeable batteries, the driving range of electric vehicles is quite limited. The same requirements are imposed on the glazing of electric vehicles as on the glazing of motor vehicles with internal combustion engines. The following legal regulations apply with regard to the size of the field of vision and the structural stability of the panes: ECE R 43: “Uniform Provisions concerning the Approval of Safety Glazing and Composite Glass Materials” as well as Technical Requirements for Vehicle Components in the Design Approval Test § 22 a StVZO [German Regulation Authorizing the Use of Vehicles for Road Traffic], No. 29 “Safety Glass”. These regulations are fulfilled, as a rule, by composite glass panes.

The field of vision of a motor vehicle pane must be kept free of ice and condensation. In the case of motor vehicles with internal combustion engines, engine heat is, as a rule, used to heat a stream of air. The warm stream of air is then directed to the panes. This method is unsuitable for electric vehicles since electric vehicles do not have engine heat. The generation of warm air from electrical energy is not very efficient. Alternatively, the pane can have an electrical heating function. The efficient use of electrical energy is thus of particular significance with electric vehicles.

There remains a need for improved heatable laminated glazing providing for uniform heating or selective heating upon demand, superior optical properties such as transparency, and improved conductivity, which can be adapted to the demand of electricity, without the need to increase the necessary power consumption.

### SUMMARY OF THE INVENTION

The present invention relates to a laminated glazing comprising:
a first and a second glass sheet, each having an internal and external surface;
at least one sheet of adhesive interlayer material serving to bond internal surfaces of said first and second glass sheets;
a first heating circuit configured to heat at least a first portion of the laminated glazing;
a second heating circuit configured to heat at least a second portion of the laminated glazing,
wherein the first and second portions at least partially overlap in an overlap region of the total laminated glazing surface.

Also provided is a method to obtain such laminated glazing.

Last provided is the use of the present laminated glazing in transportation means.

### DETAILED DESCRIPTION OF THE INVENTION

Each of the first and second glass sheet may independently be a glass of soda-lime-silica, aluminosilicate or borosilicate type, and the like. Typically, the glass sheet is float glass, having a thickness of from 0.5 to 25 mm. Glass sheets thicknesses ranging of 0.5 mm to 4 mm, may be suitable for motor vehicle glass and glass sheets thicknesses ranging of from 4 mm to 25 mm may be suitable for furniture, devices, and buildings. The composition of the glazing is not crucial for the purpose of the present invention, provided said glazing is appropriate for vehicle windows.

The glass may be clear glass, ultra-clear glass, matt glass or colored glass, comprising one or more component (s)/colorant(s) in an appropriate amount as a function of the effect desired.

Examples of colored glass include green glass, grey glass, blue glass, with varying hues and shades, depending on their compositions.

The glass sheets may independently be annealed, thermally treated, strengthened, chemically tempered, provided the function of the invention is not impaired. Methods to strengthen glass are known and will not be further described herein. However, thermal treatments comprise heating the glass sheet to a temperature of at least 560° C. in air, for example between 560° C. and 700° C., in particular around 640° C. to 670° C., during around 3, 4, 6, 8, 10, 12 or even 15 minutes according to the heat-treatment type and the thickness of the glass sheet. The treatment may comprise a rapid cooling step after the heating step, to introduce a stress difference between the surfaces and the core of the glass so that in case of impact, the so-called tempered glass sheet will break safely in small pieces. If the cooling step is less strong, the glass will then simply be heat-strengthened and in any case offer a better mechanical resistance.

Each glass sheet has an internal and an external surface. In the scope of the present invention, the internal surface of a sheet is the surface oriented towards the adhesive interlayer. The external surface of a sheet, is the surface oriented away from the adhesive interlayer. Typically, the adjacent internal surfaces of two sheets of glass are bonded together by at least one sheet of adhesive interlayer material.

In some instances, the at least one sheet of adhesive interlayer material may comprise one or more individual sub-sheet(s) of adhesive interlayer material. In those instances, the adhesive interlayer materials composing the sub-sheets may be the same or different.

Examples of adhesive interlayer materials include polyvinyl butyl (PVB), ethylene vinyl acetate (EVA), polyurethane (PU), ionomers, polymers of cyclo-olefins, ionoplast polymers, cast in place (CIP) liquid resin.

The adhesive interlayers may be provided with enhanced capabilities beyond adhesion, such as sound damping, solar control or light absorption, among others. Such further properties may be added, provided they do not impair the present invention.

The adhesive interlayer typically has a thickness ranging of from 0.30 to 1.2 mm, with typical examples at 0.38 mm and 0.76 mm.

The first and second heating circuits may be independently selected from multilayer coatings comprising at least one conductive layer, nanotubes, nanowire networks, metal grids, metal meshes, wire resistive heated circuits, micro lithographic conductors, embedded wire circuits, or the like.

### First Heating Circuit

The first heating circuit may be a multilayer coating comprising at least one conductive layer. The conductive layer may be a metallic functional layer or a conductive oxide layer, typically a doped metal oxide.

Such a multilayer coating typically has a light transmittance >60% on clear float glass, alternatively >70%, as measured according ISO9050:2003. In the scope of laminated glass for use as windshield, the light transmission of the coated glass is >70%, alternatively >75%.

In the scope of the present invention, the terms “below”, “underneath”, “under” indicate the relative position of a layer vis a vis a next layer in the multilayer coating, within the layer sequence starting from the substrate. In the scope of the present invention, the terms “above”, “upper”, “on top” , “on” indicate the relative position of a layer vis a vis a next layer in the multilayer coating, within the layer sequence starting from the substrate.

In the scope of the present invention, the relative positions of the layers within the multilayer coating do not necessarily imply direct contact. That is, some intermediate layer may be provided between the first and second layer. In some instances, a layer may actually be composed of several multiple individual layers (or sublayers). In some instances, the relative position may imply direct contact, and will be specified.

The multilayer coating may comprise n metallic functional layers and n+1 dielectric layers, wherein each metallic functional layer is surrounded by dielectric layers. In such multilayer coating, the metallic functional layer may also be known as an infrared reflecting layer. Such a multilayer coating having infrared reflective properties may serve as a solar control coating, or low emissivity coating.

The metal or metallic functional layer or infrared reflecting layer may be made of silver, gold, palladium, platinum or alloys thereof. The functional layer may have a thickness of from 2 to 22 nm, alternatively of from 5 to 20 nm, alternatively of from 8 to 18 nm. The thickness range of the functional layer will influence the conductivity, the emissivity, the anti-solar function and the light transmission of the multilayer coating.

The dielectric layers may typically comprise oxides, nitrides, oxynitrides or oxycarbides of Zn, Sn, Ti, Zr, In, Al, Bi, Ta, Mg, Nb, Y, Ga, Sb, Mg, Si and mixtures thereof. These materials may be eventually doped, where examples of dopants include aluminium, zirconium, or mixtures thereof. The dopant or mixture of dopants may be present in an amount up to 15 wt %. Typical examples of dielectric materials include, but are not limited to, silicon based oxides, silicon based nitrides, zinc oxides, tin oxides, mixed zinc-tin oxides, silicon nitrides, silicon oxynitrides, titanium oxides, aluminum oxides, zirconium oxides, niobium oxides, aluminum nitrides, bismuth oxides, mixed silicon-zirconium nitrides, and mixtures of at least two thereof, such as for example titanium-zirconium oxide.

The coating may comprise a seed layer underneath at least one functional layer, and/or the coating may comprise a barrier layer on at least one functional layer. A given functional layer may be provided with either a seed layer, or a barrier layer or both. A first functional layer may be provided with either one or both of seed and barrier layers, and a second functional layer may be provided with either one or both of seed and barrier layers and further so. These constructions are not mutually exclusive. The seed and/or barrier layers may have a thickness of from 0.1 to 35 nm, alternatively 0.5 to 25 nm, alternatively 0.5 to 15 nm, alternatively 0.5 to 10 nm.

The coating may also comprise a thin layer of sacrificial material having a thickness <15 nm, alternatively <9 nm, provided above and in contact with at least one functional layer, and which may be selected from the group comprising titanium, zinc, nickel, chrome and mixtures thereof.

The coating may optionally comprise a topcoat or top layer, as last layer, intended to protect the stack below it, from damage. Such top coat include oxides of Ti, Zr, Si, Al, or mixtures thereof; nitrides of Si, Al, or mixtures thereof ; carbon-based layers (such as graphite or diamond-like carbon).

Further examples of multilayer coating include a low emissivity coating comprising at least one silver layer, and a sequence: substrate/MeO/ZnO:AlSi/Ag/AlSi—MeO where MeO is a metallic oxide such as SnO₂, TiO₂, In₂O₃, Bi₂O₃, ZrO₂, Ta₂O₅, SiO₂ or Al₂O₃ or a mixture thereof.

Further examples of multilayer coating include those coatings comprising:

an infrared (IR) reflecting layer contacting and sandwiched between first and second layers, said second layer comprising NiCrOx; and

wherein at least said second layer comprising NiCrOx is oxidation graded so that a first portion of said second layer close to said infrared (IR) reflecting layer is less oxidized than a second portion of said second layer that is further from said infrared (IR) reflecting layer.

Examples of multilayer coating also include those coatings comprising: a dielectric layer; a first layer comprising zinc oxide located over the dielectric layer; an infrared (IR) reflecting layer comprising silver located over and contacting the first layer comprising zinc oxide; a layer comprising an oxide of NiCr located over and contacting the IR reflecting layer; a second layer comprising zinc oxide located over and contacting the layer comprising the oxide of NiCr; and another dielectric layer located over the second layer comprising zinc oxide; or those comprising: a first dielectric layer; a first infrared (IR) reflecting layer comprising silver located over at least the first dielectric layer; a first layer comprising zinc oxide located over at least the first IR reflecting layer and the first dielectric layer; a second IR reflecting layer comprising silver located over and contacting the first layer comprising zinc oxide; a layer comprising an oxide of NiCr located over and contacting the second IR reflecting layer; a second layer comprising zinc oxide located over and contacting the layer comprising the oxide of NiCr; and another dielectric layer located over at least the second layer; comprising zinc oxide.

Further suitable examples of multilayer coating include a solar control coating comprising
a base dielectric layer comprising at least a base dielectric lower layer and a base dielectric upper layer which is of a different composition to that of the base dielectric lower layer, the base dielectric upper layer comprising either one of zinc oxide or a mixed oxide of Zn and at least one additional material X, in which the ratio X/Zn in the base dielectric upper layer is between 0.02 and 0.5 by weight and in which X is one or more of the materials selected from the group comprising Sn, Al, Ga, In, Zr, Sb, Bi, Mg, Nb, Ta and Ti,
a first infra-red reflecting layer, such as silver, gold, platinum, or mixtures thereof,
a first barrier layer,
a central dielectric layer comprising at least a central dielectric lower layer and a central dielectric upper layer which is of a different composition to that of the central dielectric lower layer, the central dielectric lower layer being in direct contact with the first barrier layer and the central dielectric upper layer; the central dielectric upper layer comprising either one of zinc oxide or a mixed oxide of Zn and at least one additional material Y, in which the ratio Y/Zn in the base dielectric upper layer is between 0.02 and 0.5 by weight and in which Y is one or more of the materials selected from the group comprising Sn, Al, Ga, In, Zr, Sb, Bi, Mg, Nb, Ta and Ti,
a second infra-red reflecting layer, such as silver, gold, platinum, or mixtures thereof,
a second barrier layer,
a top dielectric layer.

A still further example of suitable multilayer coating includes a solar control coating comprising
a base dielectric layer comprising at least a base dielectric lower layer and a base dielectric upper layer which is of a different composition to that of the base dielectric lower layer, the base dielectric upper layer comprising either one of zinc oxide or a mixed oxide of Zn and at least one additional material X, in which the ratio X/Zn in the base dielectric upper layer is between 0.02 and 0.5 by weight and in which X is one or more of the materials selected from the group comprising Sn, Al, Ga, In, Zr, Sb, Bi, Mg, Nb, Ta and Ti,
a first infra-red reflecting layer, such as silver, gold, platinum, or mixtures thereof,
a first barrier layer,
a second dielectric layer comprising at least a second dielectric lower layer and a second dielectric upper layer which is of a different composition to that of the second dielectric lower layer, the second dielectric lower layer being in direct contact with the first barrier layer and the second dielectric upper layer; the second dielectric upper layer comprising either one of zinc oxide or a mixed oxide of Zn and at least one additional material Y, in which the ratio Y/Zn in the second dielectric upper layer is between 0.02 and 0.5 by weight and in which Y is one or more of the materials selected from the group comprising Sn, Al, Ga, In, Zr, Sb, Bi, Mg, Nb, Ta and Ti,
a second infra-red reflecting layer, such as silver, gold, platinum, or mixtures thereof,
a second barrier layer,
a third dielectric layer comprising at least a third dielectric lower layer and a third dielectric upper layer which is of a different composition to that of the third dielectric lower layer, the third dielectric lower layer being in direct contact with the second barrier layer and the third dielectric upper layer; the third dielectric upper layer comprising either one of zinc oxide or a mixed oxide of Zn and at least one additional material Y, in which the ratio Y/Zn in the third dielectric upper layer is between 0.02 and 0.5 by weight and in which Y is one or more of the materials selected from the group comprising Sn, Al, Ga, In, Zr, Sb, Bi, Mg, Nb, Ta and Ti,
a third infra-red reflecting layer, such as silver, gold, platinum, or mixtures thereof,
a third barrier layer,
a top dielectric layer.

In such multilayer coatings, the base dielectric upper layer may be in direct contact with the first infra-red reflecting layer. The central dielectric upper layer may be in direct contact with the second infra-red reflecting layer. The upper layers of both the base dielectric layer and the central, first and second dielectric layer may independently have a geometrical thickness within the range of about 3 to 20 nm. One or both of the additional materials X and Y may be Sn and/or Al. The proportion of Zn in the mixed oxide that forms the base dielectric upper layer and/or that which forms the central dielectric upper layer may be such that ratio X/Zn and/or the ratio Y/Zn is between about 0.03 and 0.3 by weight. The first and/or second and/or third barrier layer may be a layer comprising Ti and/or comprising an oxide of Ti, and they may each independently have a geometrical thickness of from 0.5 to 7 nm. The base dielectric upper layer and/or the central and/or the second and/or third dielectric upper layer may independently have a geometrical thickness <20 nm, alternatively <15 nm, alternatively <13 nm, alternatively <11 nm, and >3 nm, alternatively >5 nm, alternatively >10 nm. The infra-red reflecting layers may each independently have a thickness of from 2 to 22 nm, alternatively of from 5 to 20 nm, alternatively of from 8 to 18 nm. The top dielectric layer may comprise at least one layer which comprises a mixed oxide of Zn and at least one additional material W, in which the ratio W/Zn in that layer is between 0.02 and 2.0 by weight and in which W is one or more of the materials selected from the group comprising Sn, Al, Ga, In, Zr, Sb, Bi, Mg, Nb, Ta and Ti.

A specific example of such a solar control coating is provided in the table below, in which ZnSnOx is a mixed oxide containing Zn and Sn deposited by reactively sputtering a target which is an alloy or mixture of Zn and Sn, in the presence of oxygen. Alternatively, a mixed oxide layer may be formed by sputtering a target which is a mixture of zinc oxide and an oxide of an additional material, particularly in an argon gas or argon rich oxygen containing atmosphere.

The Ti barriers are deposited by sputtering a Ti target which is in an argon rich oxygen containing atmosphere to deposit a barrier that is not fully oxidized. The oxidation state in each of the base, central and top ZnSnOx dielectric layers need not necessarily be the same. Similarly, the oxidation state in each of the Ti barriers need not be the same. Each overlying barrier protects its underlying silver layer from oxidation during sputter deposition of its overlying ZnSnOx oxide layer. Whilst further oxidation of these barriers layers may occur during deposition of their overlying oxide layers a portion of these barriers may remain in metallic form or in the form of an oxide that is not fully oxidized to provide a barrier for and during subsequent heat treatment of the glazing panel.

TABLE 1

| | Geometrical | |
|---|---|---|
| (ratio of Sn/Zn by weight) | thickness | |
| Glass substrate | 2 | mm |
| Base dielectric layer comprising: | | |
| lower layer of ZnSnOx (0.7) | 20 | nm |
| upper layer of ZnSnOx (0.17) | 10 | nm |
| Ag | 10 | nm |
| Ti overlying barrier | 4 | nm |
| Central dielectric layer comprising | | |
| central lower layer of ZnSnOx (0.7) | 65 | nm |
| upper layer of ZnSnOx (0.17) | 10 | nm |
| Ag | 10 | nm |
| Ti overlying barrier | 4 | nm |
| Top dielectric layer comprising: | | |
| lower layer of ZnSnOx (0.17) | 8 | nm |
| upper layer of ZnSnOx (0.7) | 14 | nm |
| Protective overcoat of Ti | 3 | nm |

An optimal solar control coating may comprise the following sequential layers:
a base dielectric layer comprising a base dielectric lower layer and a base dielectric upper layer which is of a different composition to that of the base dielectric lower layer,
the base dielectric lower layer comprising a mixed oxide of Zn and Sn having a ratio Sn/Zn ranging from 0.5 to 2 by weight
the base dielectric upper layer comprising a mixed oxide of Zn and Sn having a ratio Sn/Zn ranging from 0.02 to 0.5 by weight
a first infra-red reflecting layer comprising metallic silver
a first barrier layer
a central dielectric layer comprising a central dielectric lower layer and a central dielectric upper layer which is of a different composition to that of the central dielectric lower layer being in direct contact with the first barrier layer and comprising a mixed oxide of Zn and Sn having a ratio Sn/Zn ranging from 0.5 to 2
the central dielectric upper layer comprising a mixed oxide of Zn and Sn having a ratio Sn/Zn ranging from 0.02 to 0.5 by weight
a second infra-red reflecting layer comprising metallic silver
a second barrier layer
a top dielectric layer.

A further optimal solar control coating according to the invention may comprise the following sequential layers:
a base dielectric layer comprising a base dielectric lower layer and a base dielectric upper layer which is of a different composition to that of the base dielectric lower layer,
the base dielectric lower layer comprising a mixed oxide of Zn and Sn having a ratio Sn/Zn ranging from 0.5 to 2 by weight
the base dielectric upper layer comprising a mixed oxide of Zn and Sn having a ratio Sn/Zn ranging from 0.02 to 0.5 by weight
a first infra-red reflecting layer comprising metallic silver
a first barrier layer
a second dielectric layer comprising a second dielectric lower layer and a second dielectric upper layer which is of a different composition to that of the second dielectric lower layer being in direct contact with the first barrier layer and comprising a mixed oxide of Zn and Sn having a ratio Sn/Zn ranging from 0.5 to 2
the second dielectric upper layer comprising a mixed oxide of Zn and Sn having a ratio Sn/Zn ranging from 0.02 to 0.5 by weight
a second infra-red reflecting layer comprising metallic silver
a second barrier layer
a third dielectric layer comprising a third dielectric lower layer and a third dielectric upper layer which is of a different composition to that of the third dielectric lower layer being in direct contact with the second barrier layer and comprising a mixed oxide of Zn and Sn having a ratio Sn/Zn ranging from 0.5 to 2
the third dielectric upper layer comprising a mixed oxide of Zn and Sn having a ratio Sn/Zn ranging from 0.02 to 0.5 by weight
a third infra-red reflecting layer comprising metallic silver
a third barrier layer
a top dielectric layer.

Multilayer coatings comprising at least one layer of conductive oxide include these conductive oxides to provide for benefits such as solar protection, light transmission, electrical conductivity, low-emissivity. Examples of metal oxide include at least one of indium oxide, zinc oxide, or a mixture thereof, optionally doped with fluorine, antimony, aluminium, gallium or hafnium.

Such multilayer coatings may include materials of higher or lower refractive indices (n) in alternating sequence. For example a multilayer coating may have a layer of material having n<1.8, a layer of material with n>1.8, a layer of material with n<1.8, and a conductive layer below or above the layer of material with n>1.8.

Another example of a multilayer coating may have a layer of material having n>1.8, a layer of material with n<1.8, a second layer of material with n<1.8, and a conductive layer between the layers of material with n<1.8. Examples of transparent conductive oxides include SnO₂:F, SnO₂:Sb or ITO (indium tin oxide), ZnO:Al, ZnO:Ga, ZnO:Hf.

Further examples of multilayer coatings include those having n layers of silver and n+1 layer of indium oxide; those having n layers of silver and n+1 layer of mixed zinc-tin oxide and a top coat of mixed oxide of gallium, indium and tin; those having n layers of silver and n+1 layer of dielectric material selected from silicon oxide, silicon oxycarbide, tin oxide, niobium oxide; those having a base layer of silicon nitride in direct contact with the substrate; those having a top layer of silicon nitride or silicon oxynitride.

Typical deposition methods of multilayer coatings on a substrate include CVD, PECVD, PVD, magnetron sputtering, wet coating, etc. Different layers of the multilayer coating may be deposited using different techniques.

Examples of substrates include glass, PVC, acrylic, polystyrene, expanded polystyrene (aeroboard), man-made rubber, polyolefins, nylon, polymeric substrates. Suitable polymeric substrates have a visible light transmission >80% , and include polyethylene terephthalate (PET), polyvinylbutyral (PVB), polyethylene naphthalate (PEN), polyethersulfon (PES), polycarbonate (PC), ethylene vinyl acetate (EVA), polyurethane (PU), and acetyl celluloid. The present polymeric substrate is different from the adhesive interlayer. Preferred substrates include glass, polyethylene terephthalate (PET), ethylene vinyl acetate (EVA).

The multilayer coating may typically be a heat treatable coating deposited on glass. Heat treatment of coated glass sheet may be the same as described above. In some instances, the multilayer coating need not be heat treatable.

The multilayer coating may have a sheet resistance of from 0.5 to 15 Ohm/square on glass.

When the multilayer coating comprises n metallic functional layers and n+1 dielectric layers, wherein each metallic functional layer is surrounded by dielectric layers, the multilayer coating may have a sheet resistance of from 0.5 to 8 Ohm/square on glass, alternatively of from 0.5 to 6 Ohm/square, alternatively of from 0.5 to 4 Ohm/square, alternatively of from 0.5 to 2.5 Ohm/square.

When the multilayer coating comprises at least one layer of conductive oxide, the multilayer coating may have a sheet resistance of from 10 to 15 Ohm/square on glass, alternatively of from 11 to 14 Ohm/square, alternatively of from 12 to 14 Ohm/square.

### Second Heating Circuit

The second heating circuit may be a metallic mesh. Such metallic mesh may also be referred to as micro-mesh, metal network, metal grid, nanowires, metal foil or the like.

The metal of the metallic mesh may be silver, gold, palladium, platinum, copper, aluminium, tungsten, or alloys thereof. The metallic mesh may be complemented by additive materials used in conjunction with the primary metal, such as conductive polymers, like poly(3,4-ethylenedioxythiophene) polystyrene sulfonate (PEDOT:PSS), or graphene.

In the scope of the present invention, the metallic mesh may be characterized by a pattern having lines and intersections, wherein the distances between two adjacent intersections may range of from 0.1 to 500 μm, alternatively of from 0.1 to 400 μm, alternatively of 0.1 to 350 μm. The largest distances between two next intersections may range of from 100 to 500 μm, while the shortest distances between intersections may range of from 0.1 to 100 μm, alternatively of from 0.1 to 70 μm. Such shorter distances allow to provide for a metallic mesh having a conducting path ranging of from 0.1 to 5 μm.

The metallic mesh may have a thickness ranging of from 1 to 800 nm, alternatively from 1 to 500 nm, alternatively from 5 to 500 nm. Exemplary thicknesses include 55 nm, 100 nm, 200 nm. The thickness of the present metallic mesh is thus <1 μm, which allows for high transparency and for an imperceptible presence by the human eye.

The pattern of the metallic mesh may or may not be organized. Organized patterns include Voronoi or Delaunay patterns. Self-organized patterns include those patterns that may or may not be predicted, and include those various spatial patterns found in physical or biological systems, like animals skin patterns, or fractals.

The metallic mesh may also be characterized by a light transmittance on glass (at a wavelength of 550 nm) >70%, alternatively >80%, alternatively >90%, said light transmittance being independent of the thickness of the metallic mesh. The haze of the metallic mesh may be <10%, alternatively <5%, alternatively <1%.

The light transmittance on glass (Tv) may be measured using illuminant A, at an angle of 2°, according to the method ISO9050.

The metallic mesh may further be characterized by a sheet resistance, dependent on its thickness and composition. For example, at a 100 nm thickness, the metallic mesh may have a sheet resistance ranging of from 7 to 100 Ohm/square, reduced down to 0.5 to 10 at a 300 nm thickness, for individual metal types. For example, a metallic mesh of silver at a thickness of 55 nm has a sheet resistance of 10 Om/square, reduced down to 2.7 Om/square at a thickness of 200 nm. Other metals will thus have differing sheets resistances, depending on their thickness, with a higher sheet resistance for thinner thicknesses, thus sheet resistance decreases with increasing metallic mesh thickness. The minimum sheet resistance of such a metallic mesh may range of from 0.5 to 10 Ohm/square for a thickness of 300 nm.

Sheet resistance measurement may be conducted using inductive measurements using a Stratometer G, having no pins contacting the layers (Nagy Instruments, Germany).

An alternative method for sheet resistance measurement is the four-probe test method, wherein four sharp probes (usually with zinc coated tips) are placed on a flat surface of the material to be measured, current is passed through the two outer electrodes, and the floating potential if measured across the inner pair.

The metallic mesh, despite its thickness <1 μm, allows for efficient conductivity.

The metallic mesh may be prepared by various methods, such as lithography, direct printing, laser printing, screen printing, sheet to sheet printing, gravure offset techniques, flexographic printing, roller coating, spraying, curtain coating, decal application, roll to roll printing, cracking or any other known method.

The metallic mesh may typically be prepared by cracking from polymer templates. Such a process of metallic mesh preparation includes the steps of
1) applying a colloidal polymer suspension on a substrate
2) preparing a crack layer by drying said colloidal suspension
2) depositing a metal on the crack layer,
3) washing away the dried crack layer
4) obtaining a metallic mesh.

Examples of colloidal suspensions include those suspension of polystyrene, poly(methyl methacrylate) (PMMA), poly(methyl acrylate) (PMA), poly(ethyl acrylate) (PEA), poly(butyl acrylate) (PBA), poly(allyl methacrylate) (PAMA), poly(2-ethoxylethyl methacrylate), poly(allyl chloride), polyurethane, epoxy, polyacrylamide, polypyrrole, polyaniline, poly(p-phenylene vinylene) (PPV), poly(2-hydroxyethyl methacrylate), poly(vinyl acetate), poly(ethyl methacrylate-co-methyl acrylate), poly-a-methylstyrene, and poly(methylmethacrylate-co-butyl methacrylate), silica nanoparticles, or mixtures thereof. Typical colloidal suspensions useful to obtain the present metallic mesh are those obtained from (meth)acrylic based materials, including poly(methyl methacrylate (PMMA), poly(methyl acrylate) (PMA), poly(ethyl acrylate) (PEA), poly(butyl acrylate) (PBA), poly(allyl methacrylate) (PAMA), poly(2-ethoxylethyl methacrylate).

Examples of substrates include glass, PVC, acrylic, polystyrene, expanded polystyrene (aeroboard), man-made rubber, polyolefins, nylon, polymeric substrates. Suitable polymeric substrates have a visible light transmission >80% , and include polyethylene terephthalate (PET), polyvinylbutyral (PVB), polyethylene naphthalate (PEN), polyethersulfon (PES), polycarbonate (PC), ethylene vinyl acetate (EVA), polyurethane (PU), and acetyl celluloid. The present polymeric substrate is different from the adhesive interlayer.

Typical example of substrate for the metallic mesh include glass, and polymeric substrates, like polyethylene terephthalate (PET), polyvinylbutyral (PVB), ethylene vinyl acetate (EVA), polyurethane (PU) or the like. The light transmittance (at a wavelength of 550 nm) of the metallic mesh on a polyethylene film may be >70%, alternatively >75%. Preferred substrates include glass, polyethylene terephthalate (PET), ethylene vinyl acetate (EVA).

The polymeric substrate has a first surface and a second surface opposite of the first surface.

The thickness of the polymeric substrate may range of from 12.5 to 500 μm, alternatively of from 30 to 150 μm, alternatively of from 40 μm to 80 μm.

The drying of the colloidal suspension may be conducted at temperatures ranging of form 15 to 100° C., alternatively of from 15 to 70° C., alternatively of from 15 to 30° C. the drying typically induces spontaneous cracking of the polymer layer as template to prepare the metallic network.

The deposition of the metal on the crack layer may be conducted by any known deposition technique, including chemical vapor deposition (CVD), plasma enhanced chemical vapor deposition (PECVD), physical vapor deposition (PVD), magnetron sputtering, vacuum evaporation, wet coating, printing, spraying, etc. Examples of suitable methods include chemical vapor deposition, magnetron sputtering, vacuum evaporation.

The washing away of the dried crack polymer may be carried out using any solvent able to dissolve the selected polymer. Examples of solvent include acetone, benzene, chloroform, water, methyl ethyl ketone, butylated hydroxytoluene, xylene, tetralin, decalin. The removal of the dried crack polymer may also be effected by physical such as ultrasonication.

The resulting metallic mesh is formed of highly interconnected metallic lines within the polymer cracks, and may be characterized by a fill factor of >20% with a structural width of 1 to 4 μm. The arbitrary self-organized structure allows for elimination of Moiré patterns.

The process may be carried out by roll to roll printing.

The metallic mesh of the second heating circuit may thus be characterized by either one of
a distance between two adjacent intersections ranging of from 0.1 to 500 μm, or
a thickness ranging of from 1 to 800 nm, or
a conducting path ranging of from 0.1 to 5 μm, or
a light transmittance on glass (at a wavelength of 550 nm) >70%, or
a minimum sheet resistance range of from 0.5 to 10 Ohm/square for a thickness of 300 nm.

Each of these parameter allows to provide for a second heating circuit in the form of a metallic mesh having an efficient and homogenous transparent web distribution over the surface of the laminated glazing. Such a metallic mesh is thus transparent to the human eye, that is, substantially imperceptible by the human eye, and as such, allows for plain visibility through the laminated glazing. The transparency of such a metallic mesh allows for its positioning over any or all viewing area of the laminated glazing, that is, the presence of the second heating circuit does not require to be masked or hidden in an enameled or painted area of the laminated glazing.

Furthermore, the structure of such a second heating circuit in the form of the present metallic mesh prevents overheating in localized areas by its homogeneous repartition in the laminated glazing area.

The narrow conducting path or the sheet resistance are independently indicative of the conductivity efficiency of the metallic mesh.

In some instances, the metallic mesh of the second heating circuit may alternatively be characterized by two or more of
a distance between two adjacent intersections ranging of from 0.1 to 500 μm, or
a thickness ranging of from 1 to 800 nm, or
a conducting path ranging of from 0.1 to 5 μm, or
a light transmittance on glass (at a wavelength of 550 nm) >70%, or
a minimum sheet resistance range of from 0.5 to 10 Ohm/square for a thickness of 300 nm.

For example, the metallic mesh may be characterized by a distance between two adjacent intersections ranging of from 0.1 to 500 μm and a thickness ranging of from 1 to 800 nm; or by a distance between two adjacent intersections ranging of from 0.1 to 500 μm and a conducting path ranging of from 0.1 to 5 μm; or by a distance between two adjacent intersections ranging of from 0.1 to 500 μm and a light transmittance on glass (at a wavelength of 550 nm) >70%; or by a distance between two adjacent intersections ranging of from 0.1 to 500 μm and a minimum sheet resistance range of from 0.5 to 10 Ohm/square for a thickness of 300 nm; or by a thickness ranging of from 1 to 800 nm and a conducting path ranging of from 0.1 to 5 μm; or by a thickness ranging of from 1 to 800 nm and a light transmittance on glass (at a wavelength of 550 nm) >70%; or by a thickness ranging of from 1 to 800 nm and a minimum sheet resistance range of from 0.5 to 10 Ohm/square for a thickness of 300 nm; or by a conducting path ranging of from 0.1 to 5 μm and a light transmittance on glass (at a wavelength of 550 nm) >70%; or by a conducting path ranging of from 0.1 to 5 μm and a minimum sheet resistance range of from 0.5 to 10 Ohm/square for a thickness of 300 nm; or by a light transmittance on glass (at a wavelength of 550 nm) >70% and a minimum sheet resistance range of from 0.5 to 10 Ohm/square for a thickness of 300 nm; or by a distance between two adjacent intersections ranging of from 0.1 to 500 μm and a thickness ranging of from 1 to 800 nm and a conducting path ranging of from 0.1 to 5 μm; or by a distance between two adjacent intersections ranging of from 0.1 to 500 μm and a thickness ranging of from 1 to 800 nm and a light transmittance on glass (at a wavelength of 550 nm) >70%; or by a distance between two adjacent intersections ranging of from 0.1 to 500 μm and a thickness ranging of from 1 to 800 nm and a minimum sheet resistance range of from 0.5 to 10 Ohm/square for a thickness of 300 nm; or by a distance between two adjacent intersections ranging of from 0.1 to 500 μm and a thickness ranging of from 1 to 800 nm and a conducting path ranging of from 0.1 to 5 μm and a light transmittance on glass (at a wavelength of 550 nm) >70%; or by a distance between two adjacent intersections ranging of from 0.1 to 500 μm and a thickness ranging of from 1 to 800 nm and a conducting path ranging of from 0.1 to 5 μm and a light transmittance on glass (at a wavelength of 550 nm) >70% and a minimum sheet resistance range of from 0.5 to 10 Ohm/square for a thickness of 300 nm, or any other possible combination.

A metallic mesh with a thickness <1 μm allows for plain visibility and homogeneous repartition of the heating, preventing overheating in localized areas of the laminated glazing, together with superior conductivity.

### Embodiments

The present laminated glazing thus comprises:
a first and a second glass sheet, each having an internal and external surface;
at least one sheet of adhesive interlayer material serving to bond internal surfaces of said first and second glass sheets;
a first heating circuit configured to heat at least a first portion of the laminated glazing;
a second heating circuit configured to heat at least a second portion of the laminated glazing,
wherein the first and second portions at least partially overlap in an overlap region of the total laminated glazing surface.

There exist various configurations of the present laminated glazing encompassed within the scope of the present invention, which include assembling the different glass sheets, the at least one sheet of adhesive interlayer and the first and second heating circuits, wherein the portions of the laminated glazing covered by the first and second heating circuits at least partially overlap.

In the scope of the present invention, the term “present on” indicates the relative position of a heating circuit vis a vis its substrate does not necessarily imply direct contact. However, in typical instances, the term “present on” will imply direct contact.

In a first configuration, the first heating circuit is present on at least a first portion of the internal surface of at least one of the first or second glass sheets (P2 or P3), and the second heating circuit is present on at least a second portion of the same glass sheet, where the first and second portions may at least partially overlap. The first heating circuit may be deposited first on the glass substrate, and the second heating circuit may be deposited in a second step on the same glass substrate, or the second heating circuit may be deposited first on the glass substrate, and the first heating circuit may be deposited in a second step on the same glass substrate. That is, in the portion of overlap, the second heating circuit may be located over the first heating circuit, or the first heating circuit may be located over the second heating circuit. In some instances, there is contact between the first and second heating circuits, in other instances, there may be no contact between them, although their respective covered portions physically overlap in the portion of overlap.

In such a first configuration, the first glass sheet and the second glass sheet will be assembled by means of the at least one adhesive interlayer material to provide for the laminated glazing.

In a second configuration, the first heating circuit is present on at least a first portion of the internal surface of the first glass sheet (P2 or P3), and the second heating circuit is present on at least a second portion of the internal surface of the second glass sheet (P3 or P2), where the first and second portions may at least partially overlap when the first glass sheet and the second glass sheet are assembled by means of the at least one adhesive interlayer material to provide for the laminated glazing.

In a third configuration, the first heating circuit is present on at least a first portion of the internal surface of at least one of the first or second glass sheets (P2 or P3), and the second heating circuit is present on at least a portion of one of the first or second surface of a polymeric substrate such as those described above. The polymeric substrate is thus provided with the second heating circuit on at least a portion of one of its surfaces, and may be referred to as a coated polymeric substrate CS3. The said coated polymeric substrate CS3 may be assembled between two sheets of adhesive interlayer material, forming for a multiple sheet adhesive interlayer material.

In such a third configuration, the first glass sheet and the second glass sheet will be assembled by means of at least the multiple sheet adhesive interlayer material to provide for the laminated glazing, such that the first portion (on the glass sheet) and the second portion (on the coated polymeric substrate 083) at least partially overlap.

In such a third configuration, the second heating circuit may be facing the first glass sheet or may be facing the second glass sheet. In such a configuration, the first heating circuit on the internal surface of at least one of the first or second glass sheets (on P2 or P3) may be facing the second heating circuit present on the coated polymeric substrate CS3 (on P2′ or P3′, respectively)—configuration 3a, or may not be facing it (on P′ or P2′, respectively)—configuration 3b.

In a fourth configuration, the first heating circuit is present on at least a portion of the first surface of a polymeric substrate such as those described above, and the second heating circuit is present on at least a portion of the second surface of the same polymeric substrate such as those described above. The polymeric substrate is thus provided with the first and the second heating circuits on its opposite surfaces, such that the first and second portion at least partially overlap, and may be referred to as a coated polymeric substrate CS4. The said coated polymeric substrate CS4 may be assembled between two sheets of adhesive interlayer material, forming for a multiple sheet adhesive interlayer material.

In such a fourth configuration, the first glass sheet and the second glass sheet will be assembled by means of at least the multiple sheet adhesive interlayer material to provide for the laminated glazing, wherein the first portion and the second portion at least partially overlap.

In such a fourth configuration, the coated polymeric substrate CS4 may be placed such that the first heating circuit is oriented towards the first glass sheet or the second glass sheet, and thus the second heating circuit is oriented towards the second glass sheet or the first glass sheet.

In a fifth configuration, the first heating circuit is present on at least a portion of the first surface of a polymeric substrate such as those described above, and the second heating circuit is present on at least a portion of the same surface of the same polymeric substrate such as those described above. The polymeric substrate is thus provided with the first and the second heating circuits on the same surface, such that the first and second portion at least partially overlap, and may be referred to as a coated polymeric substrate CS5. The first heating circuit may be deposited first on the polymeric substrate, and the second heating circuit may be deposited in a second step on the same surface of the polymeric substrate, or the second heating circuit may be deposited first, and the first heating circuit may be deposited in a second step. That is, in the portion of overlap, the second heating circuit may be located over the first heating circuit, or the first heating circuit may be located over the second heating circuit. In some instances, there is contact between the first and second heating circuits, in other instances, there may be no contact between them, although their respective covered portions physically overlap in the portion of overlap. The said coated polymeric substrate CS5 may be assembled between two sheets of adhesive interlayer material, forming for a multiple sheet adhesive interlayer material.

In such a fifth configuration, the first glass sheet and the second glass sheet will be assembled by means of at least the multiple sheet adhesive interlayer material to provide for the laminated glazing, wherein the first portion and the second portion at least partially overlap.

In such a fifth configuration, the coated polymeric substrate CS5 may be placed such that the coated surface is oriented towards the exterior glass sheet or the interior glass sheet.

Such a fifth configuration is provided with a reduced cost of production.

In these various configurations, the first and second heating circuits may be the same or different. Typically, the first heating circuit may be a multilayer coating, and the second heating circuit may be a metallic mesh prepared as described above. In these various configurations, the first heating circuit is preferably a multilayer coating comprising n metallic functional layers and n+1 dielectric layers, wherein each metallic functional layer is surrounded by dielectric layers n, or a multilayer coating comprising at least one layer of conductive oxide. In these various configurations, the second heating circuit is preferably a metallic mesh characterized as described above.

In some instances, it may however be envisaged that the first and second heating circuits both be a metallic mesh prepared as described above, the same or different. In those instances, portions of the first and second glass sheets may each be provided with the same or different metallic mesh, or portions of the polymeric substrate may each be provided with the same or different metallic mesh, provided said portions at least partially overlap.

In the scope of the present invention, the first and second heating circuits at least partially overlap in an overlap region of the total laminated glazing surface when the laminated glazing is assembled. That is, at least one portion of the laminated glazing will be provided with both first and second heating circuits in a superposed position, with the layers of glass and adhesive interlayer material and optional polymeric substrate around and/or in-between.

The overlap region represents a surface percentage of the total laminated glazing according to either one of
a small delimited area of the laminated glazing of less than 10% of the total laminated glazing surface, or
for middle size area representing 10 to 50% of the total laminated glazing surface, or
for large size area representing 51 to 90% of the total laminated glazing surface.

The total overlap area may be a single area or multiple divisions and areas. The size of the overlap region will vary in view of the final use of the laminated glazing.

The combination of the present two heating circuits, each having high transparency, allows for the overlap region to be a transparent viewing area of the laminated glazing. Such transparent viewing area is typically required for laminated glazings for use as vehicle windshield or window.

Since both first and second heating circuits are transparent, they may thus be positioned over any or all viewing area of the laminated glazing. As discussed above, the presence of the second heating circuit does not require to be masked or hidden in an enameled or painted area of the laminated glazing.

In some instances, an insulated area may be designed within the laminated glazing, be it in the total surface of the laminated glazing or in the overlap region. This means that none of the first and/or second heating circuit is present in the insulated area. The one or more insulated area may have an electrical resistance such that substantially no electrical current flows through it when a voltage is applied and thus may be substantially not conductive.

The one or more insulated area may be provided by applying pattern wise to the substrate a masking agent before depositing the first and/or second heating circuit and subsequently removing the masking agent covered with the said heating circuit. Alternatively, the one or more insulated area may be provided by removal of the first and/or second heating circuit after deposition.

Such insulated area may be useful in instances where specific electromagnetic waves or signals need to pass through the laminated glazing and not be impaired by either one of the first and/or second heating circuit.

Furthermore, such an electromagnetic wave transparent insulated area may be obtained by partial masking or partial removal of either one of the first and/or second heating circuit.

The first and second heating circuits are arranged in the interior of the laminated glazing and are thus mechanically as well as chemically protected, for example, against corrosion, by the exterior and interior glass panes.

In all configurations, it may also be envisaged that the laminated glazing further comprises at least one additional glass sheet and at least one additional sheet of adhesive interlayer material to provide for laminated glazings having more than 2 sheets of glass, such as triple glazings, fire resistant glazings or safety glazings. In such events, the additional glass sheets and adhesive interlayers will be positioned on either side of the present laminated glazing.

In some instances, it may also be envisaged to add further glass sheets and/or adhesive interlayer materials to provide for multiple glazings having more than 2 sheets of glass, which further glass sheets and/or adhesive interlayer materials would be positioned between the interior and exterior glass sheets. In such configurations, the first or second heating circuit may be located within the laminated glazing, within layers of adhesive interlayer, and the second or first heating circuit may be applied outside of the laminated glazing, not within the adhesive interlayer bonding the two glass sheets, but between an adhesive interlayer bonding the laminated glazing to a third glass sheet, said third glass sheet may for example be comprised of glass having a thickness of from 0.1 to 1.8 mm.

In all configurations, it may be envisaged that the laminated glazing further comprises at least one other multilayer coating stack on at least one surface of the different glass sheets not bearing any of the first or second heating circuits, such as photocatalytic coatings, antireflective coatings or the like, provided the present laminated glazing remains suitable for its function. Said “other” multilayer coating may have the same structure of layers or different from the multilayer coating serving as first heating circuit, described above.

In all configurations, it may be envisaged that the at least one sheet of glass of the laminated glazing is thermally treated, as described above.

In the above configurations, the glass sheets may individually be subjected to a bending type of heat treatment to provide for bent or shaped glass. Bending processes are known in the art and will not be described herein.

The lamination processes are also known in the art and will not be described herein.

The laminated glazing may further comprise busbars and necessary means for providing for the electrical power supply required to heat the laminated glazing. The first and second heating circuits need not be in contact with one another, but electrical supply will be adapted such that their function is not impaired. Means for electrical insulation may be provided and adapted such that the function of the present laminated glazing is not impaired.

A further aspect of the invention comprises a method for producing a laminated glazing according to the invention, comprising the steps of
1) providing for
a first and a second glass sheet, each having an internal and external surface;
at least one sheet of adhesive interlayer material serving to bond the internal surfaces of said first and second glass sheets;
a first heating circuit configured to heat at least a first portion of the laminated glazing; and
a second heating circuit configured to heat at least a second portion of the laminated glazing,
2) laminating the first and second glass sheets with the at least one sheet of adhesive interlayer material, wherein the first and second portions at least partially overlap in an overlap region of the total laminated glazing surface.

When the first heating circuit is a multilayer coating, it may be provided by typical deposition methods of multilayer coatings on a substrate include CVD, PECVD, PVD, magnetron sputtering, wet coating.

When the second heating circuit is a metallic mesh, it may be provided by the process of metallic mesh preparation described above, including the steps of
1) applying a colloidal polymer suspension on a substrate
2) preparing a crack layer by drying said colloidal suspension
2) depositing a metal on the crack layer,
3) washing away the dried crack layer
4) obtaining a metallic mesh.

The present process allows for efficient and robust preparation of a conductive and reliable metallic mesh, that is imperceptible to the human eye, as described above.

The present invention provides for the use of the present laminated glazing as a heatable glazing for means of transportation for travel on land, in the air, or on water, in particular in motor vehicles. Such heatable vehicle glazing includes windshield, rear window, side windows, sun roof, panoramic roof or any other window useful in a vehicle or transportation means.

The laminated glazing according to the invention may be used as a motor vehicle window in motor vehicles that are driven by conversion of electrical energy, in particular in electric vehicles. The electrical energy is drawn from accumulators, rechargeable batteries, fuel cells, or internal combustion engine driven generators.

The laminated glazing according to the invention may be used as a motor vehicle window in hybrid electric motor vehicles that are driven by conversion of another energy form besides conversion of electrical energy. The other energy form is preferably an internal combustion engine, in particular a diesel engine.

The laminated glazing according to the invention may be used as well as a functional individual piece, and as a built-in part in architectural applications, construction applications, as built-in component in furniture or devices, for example as an electrical heater.

Typically, conventional heaters with electrically conductive coatings may be operated with the customary onboard voltage with a DC voltage of 12 V to 14 V or, in the case of higher required heat output, with DC voltages up to 42 V. For DC voltages >75 V (up to 450 V), safety precautions need to be included. For heaters that are operated with AC voltage, safety precautions need to be included from an AC voltage >25 V (up to 450 V).

Typically, the sheet resistance, depending on the voltage available and the necessary heat output, may range of from 0.5 Ohm/square to 5 Ohm/square. Under these conditions, an iced windshield can be deiced in 5 to 10 minutes in winter.

The construction of the present laminated glazing provided with a first and a second heating circuit allows the independent control of each said heating circuits independently from the other. Each heating circuit may thus be electrically powered and regulated independently from the other, and provide for its heating function upon demand. The two heating circuits may also be electrically powered and regulated simultaneously. Thus the first and second portions of the laminated glazing may be heated independently and in the overlap region the laminated glazing may benefit from the heating power of both first and second heating circuits.

Such adaptation is useful to manage the amount of power remaining in a battery and allows for distribution of a current where and when it is most appropriate, that is, the selection of power consumption directed to heating and to other functions of the electric supply may be allocated as most required. For example, upon de-icing in the winter, both the first and second heating circuits may be directed to their heating function upon ignition of the vehicle. Once the de-icing is terminated, and a minor amount heating is still required, only one of the first or second heating circuit may be electrically powered and regulated. The energy thus initially required may then be either saved or allocated to another function. In other circumstances, in case of malfunctioning of either one of the first or second heating circuit, the other one may still be functioning independently and ensure safe functioning of the laminated glazing.

In typical circumstances, multilayer coatings on glass or on polymer substrates may have a sheet resistance ranging of from 0.5 to 1.0 Ohm/square for multilayer coatings comprising 3 or more silver layers. Such multilayer coatings comprising 3 or more silver layers are especially beneficial for their solar control properties. In other typical circumstances, multilayer coatings on glass or on polymer substrates may have a sheet resistance ranging of from 2.0 to 3.0 Ohm/square for multilayer coatings comprising 2 silver layers. In other typical circumstances, multilayer coatings on glass or on polymer substrates may have a sheet resistance ranging of from 4.0 to 6.0 Ohm/square for multilayer coatings comprising 1 silver layer. In other typical circumstances, multilayer coatings on glass or on polymer substrates may have a sheet resistance ranging of from 11.0 to 15.0 Ohm/square for multilayer coatings comprising a conductive oxide functional layer.

In typical circumstances, the metallic mesh may have a sheet resistance, ranging of from 2 to 90 Ohm/square, depending on the considered conductive metal, as further described above. When the metallic mesh is of silver metal, the metallic mesh may have a sheet resistance, ranging of from 1 to 10 Ohm/square, alternatively of from 1 to 5 Ohm/square.

The first advantage of the present invention lies in the fact that the first and second heating circuits may be electrically powered and regulated simultaneously or interdependently, according to the specific requirements, without the need to increase the necessary voltage and as such, without the need to increase safety risks of using too high voltages (>75 V in Dc, or >25 V in AC). The lower the sheet resistance of a heating circuit, the lower the heating power it is able to generate. It is therefore particularly advantageous to combine a first heating circuit having low sheet resistance, such as for example a multilayer coating, in particular comprising 3 or more silver layers, with a second heating circuit providing additional heating power, such as for example a metallic mesh as described above.

Another advantage is that when the first heating circuit is a multilayer coating and the second heating circuit is a metallic mesh, at least one of said heating circuit may be deposited on a polymer substrate, such that cost of production may be reduced.

In other instances, when the first heating circuit is a multilayer coating and the second heating circuit is a metallic mesh having a thickness <1 μm, they may both be provided on the same support, either a polymer substrate or a glass substrate. In those instances, cost of production may be significantly reduced.

That is, the metallic mesh is characterized by either one of
a distance between two adjacent intersections ranging of from 0.1 to 500 μm, or
a thickness ranging of from 1 to 800 nm, or
a conducting path ranging of from 0.1 to 5 μm, or
a light transmittance on glass (at a wavelength of 550 nm) >70%, or
a minimum sheet resistance range of from 0.5 to 10 Ohm/square for a thickness of 300 nm, such as described above may be used in a laminated glazing, in any of the configurations above.

Specifically, a metallic mesh characterized by thickness ranging of from 1 to 800 nm such as described above, may be used in a laminated glazing, in any of the configurations above.

The present invention may be described by the below clauses.

Clause 1 pertains to a laminated glazing comprising:
a first and a second glass sheet, each having an internal and external surface;
at least one sheet of adhesive interlayer material serving to bond the internal surfaces of said first and second glass sheets;
a first heating circuit configured to heat at least a first portion of the laminated glazing;
a second heating circuit configured to heat at least a second portion of the laminated glazing,
wherein the first and second portions at least partially overlap in an overlap region of the total laminated glazing surface.

Clause 2 pertains to a laminated glazing of clause 1, wherein the first heating circuit comprises a multilayer coating comprising at least one electrically conductive layer.

Clause 3 pertains to a laminated glazing of any one of the preceding clauses, wherein the adhesive interlayer material is selected from polyvinyl butyl (PVB), ethylene vinyl acetate (EVA), polyurethane (PU), ionomers, polymers of cyclo-olefins, ionoplast polymers, cast in place (CIP) liquid resin.

Clause 4 pertains to a laminated glazing of any one of the preceding clauses, wherein the second heating circuit comprises a metallic mesh.

Clause 5 pertains to a laminated glazing of any one of the preceding clauses and of clause 4 , wherein the metallic mesh is characterized by either one of
a distance between two adjacent intersections ranging of from 0.1 to 500 μm, or
a thickness ranging of from 1 to 800 nm, or
a conducting path ranging of from 0.1 to 5 μm, or
a light transmittance on glass (at a wavelength of 550 nm) >70%, or
a minimum sheet resistance range of from 0.5 to 10 Ohm/square for a thickness of 300 nm.

An alternative clause 5 pertains to a laminated glazing of any one of the preceding clauses and of clause 4 , wherein the metallic mesh is characterized by two or more of
a distance between two adjacent intersections ranging of from 0.1 to 500 μm, or
a thickness ranging of from 1 to 800 nm, or
a conducting path ranging of from 0.1 to 5 μm, or
a light transmittance on glass (at a wavelength of 550 nm) >70%, or
a minimum sheet resistance range of from 0.5 to 10 Ohm/square for a thickness of 300 nm.

Clause 6 pertains to a laminated glazing of any one of the preceding clauses, further comprising a polymeric substrate having a first surface and a second surface opposite of the first surface.

Clause 7 pertains to a laminated glazing of any one of the preceding clauses, wherein the polymeric substrate is different from the adhesive interlayer material and is selected from polyethylene terephthalate (PET), polyvinylbutyral (PVB), polyethylene naphthalate (PEN), polyethersulfon (PES), polycarbonate (PC), ethylene vinyl acetate (EVA), polyurethane (PU), and acetyl celluloid.

Clause 8 pertains to a laminated glazing of any of clauses 1 to 5, wherein the first heating circuit is present on at least a first portion of the internal surface of one of the first or second glass sheet and the second heating circuit is present on at least a second portion of the same glass sheet.

Clause 9 pertains to a laminated glazing of any of clauses 1 to 5, wherein the first heating circuit is present on at least a portion of the internal surface of the first glass sheet, and the second heating circuit is present on at least a portion of the internal surface of the second glass sheet.

Clause 10 pertains to a laminated glazing of any one of clauses 6 or 7, wherein the first heating circuit is present on at least a portion of the internal surface of at least one of the first or second glass sheets, and the second heating circuit is present on at least a portion of one of the first or second surfaces of the polymeric substrate.

Clause 11 pertains to a laminated glazing of any one of clauses 6 or 7, wherein the first heating circuit is present on at least a portion of the first surface of the polymeric substrate, and the second heating circuit is present on at least a portion of the second surface of the polymeric substrate.

Clause 12 pertains to a laminated glazing of any one of clauses 6 or 7, wherein the first heating circuit is present on at least a first portion of the first surface of the polymeric substrate, and the second heating circuit is present on at least a second portion of the same surface of the polymeric substrate.

Clause 13 pertains to a laminated glazing of clause 1, wherein the first heating circuit and the second heating circuit both comprise a metallic mesh.

Clause 14 pertains to a laminated glazing of any of the preceding clauses, wherein the overlap region represents a surface percentage of the total laminated glazing represents either one of:
less than 10% of the total laminated glazing surface, or
10 to 50% of the total laminated glazing surface, or
51 to 90% of the total laminated glazing surface.

Clause 15 pertains to a laminated glazing of any of the preceding clauses, further comprising at least one additional glass sheet and at least one additional sheet of interlayer material to provide for laminated glazings having more than 2 sheets of glass.

Clause 16 pertains to a laminated glazing of any of the preceding clauses, wherein the laminated glazing further comprises at least one other multilayer coating on at least one uncoated surface of any of the glass sheets.

Clause 17 pertains to a laminated glazing of any of the preceding clauses, wherein at least one sheet of glass is annealed, thermally treated, strengthened, chemically tempered.

Clause 18 pertains to a method for producing a laminated glazing, comprising the steps of
1) providing for
a first and a second glass sheet, each having an internal and external surface;
at least one sheet of adhesive interlayer material serving to bond the internal surfaces of said first and second glass sheets;
a first heating circuit configured to heat at least a first portion of the laminated glazing; and
a second heating circuit configured to heat at least a second portion of the laminated glazing,
2) laminating the first and second glass sheets with the at least one sheet of adhesive interlayer material,
wherein the first and second portions at least partially overlap in an overlap region of the total laminated glazing surface.

Clause 19 pertains to the use of a laminated glazing according to any of claims 1 to 17, as a heatable glazing for means of transportation for travel on land, in the air, or on water, in particular in motor vehicles.

Clause 20 pertains to the use of a metallic mesh characterized by either one of
a distance between two adjacent intersections ranging of from 0.1 to 500 μm, or
a thickness ranging of from 1 to 800 nm, or
a conducting path ranging of from 0.1 to 5 μm, or
a light transmittance on glass (at a wavelength of 550 nm) >70%, or
a minimum sheet resistance range of from 0.5 to 10 Ohm/square for a thickness of 300 nm, in a laminated glazing.

Clause 21 pertains to the use of a metallic mesh characterized by a thickness ranging of from 1 to 800 nm, in a laminated glazing.

Clause 22 pertains to the use of a metallic mesh characterized by two or more of
a distance between two adjacent intersections ranging of from 0.1 to 500 μm, or
a thickness ranging of from 1 to 800 nm, or
a conducting path ranging of from 0.1 to 5 μm, or
a light transmittance on glass (at a wavelength of 550 nm) >70%, or
a minimum sheet resistance range of from 0.5 to 10 Ohm/square for a thickness of 300 nm, in a laminated glazing.

Clause 23 pertains to the use of a metallic mesh characterized by a distance between two adjacent intersections ranging of from 0.1 to 500 μm and a thickness ranging of from 1 to 800 nm; or by a distance between two adjacent intersections ranging of from 0.1 to 500 μm and a conducting path ranging of from 0.1 to 5 μm; or by a distance between two adjacent intersections ranging of from 0.1 to 500 μm and a light transmittance on glass (at a wavelength of 550 nm) >70%; or by a distance between two adjacent intersections ranging of from 0.1 to 500 μm and a minimum sheet resistance range of from 0.5 to 10 Ohm/square for a thickness of 300 nm; or by a thickness ranging of from 1 to 800 nm and a conducting path ranging of from 0.1 to 5 μm; or by a thickness ranging of from 1 to 800 nm and a light transmittance on glass (at a wavelength of 550 nm) >70%; or by a thickness ranging of from 1 to 800 nm and a minimum sheet resistance range of from 0.5 to 10 Ohm/square for a thickness of 300 nm; or by a conducting path ranging of from 0.1 to 5 μm and a light transmittance on glass (at a wavelength of 550 nm) >70%; or by a conducting path ranging of from 0.1 to 5 μm and a minimum sheet resistance range of from 0.5 to 10 Ohm/square for a thickness of 300 nm; or by a light transmittance on glass (at a wavelength of 550 nm) >70% and a minimum sheet resistance range of from 0.5 to 10 Ohm/square for a thickness of 300 nm; or by a distance between two adjacent intersections ranging of from 0.1 to 500 μm and a thickness ranging of from 1 to 800 nm and a conducting path ranging of from 0.1 to 5 μm; or by a distance between two adjacent intersections ranging of from 0.1 to 500 μm and a thickness ranging of from 1 to 800 nm and a light transmittance on glass (at a wavelength of 550 nm) >70%; or by a distance between two adjacent intersections ranging of from 0.1 to 500 μm and a thickness ranging of from 1 to 800 nm and a minimum sheet resistance range of from 0.5 to 10 Ohm/square for a thickness of 300 nm; or by a distance between two adjacent intersections ranging of from 0.1 to 500 μm and a thickness ranging of from 1 to 800 nm and a conducting path ranging of from 0.1 to 5 μm and a light transmittance on glass (at a wavelength of 550 nm) >70%; or by a distance between two adjacent intersections ranging of from 0.1 to 500 μm and a thickness ranging of from 1 to 800 nm and a conducting path ranging of from 0.1 to 5 μm and a light transmittance on glass (at a wavelength of 550 nm) >70% and a minimum sheet resistance range of from 0.5 to 10 Ohm/square for a thickness of 300 nm; or any other possible combination, in a laminated glazing.

1. A laminated glazing comprising:
a first glass sheet and a second glass sheet, each having an internal surface and an external surface;
at least one sheet of adhesive interlayer material serving to bond the internal surfaces of the first glass sheet and the second glass sheet;
a first heating circuit configured to heat at least a first portion of the laminated glazing; and
a second heating circuit configured to heat at least a second portion of the laminated glazing,
wherein the first and second portions of the laminated glazing at least partially overlap in an overlap region of a total laminated glazing surface.

2. The laminated glazing of claim 1, wherein the first heating circuit comprises a multilayer coating comprising at least one electrically conductive layer.

3. The laminated glazing of claim 1, wherein the adhesive interlayer material is selected from a group consisting of polyvinyl butyl (PVB), ethylene vinyl acetate (EVA), polyurethane (PU), ionomers, polymers of cyclo-olefins, ionoplast polymers, and cast in place (CIP) liquid resin.

4. The laminated glazing of claim 1, wherein the second heating circuit comprises a metallic mesh.

5. The laminated glazing of claim 4, wherein the metallic mesh comprises:
a distance between two adjacent intersections ranging from 0.1 to 500 μm, or
a thickness ranging from 1 to 800 nm, or
a conducting path ranging from 0.1 to 5 μm, or
a light transmittance on glass (at a wavelength of 550 nm) >70%, or
a minimum sheet resistance range from 0.5 to 10 Ohm/square for a thickness of 300 nm.

6. The laminated glazing of claim 1, further comprising a polymeric substrate having a first surface and a second surface opposite of the first surface.

7. The laminated glazing of claim 6, wherein the polymeric substrate is different from the adhesive interlayer material and is selected from a group consisting of polyethylene terephthalate (PET), polyvinylbutyral (PVB), polyethylene naphthalate (PEN), polyethersulfon (PES), polycarbonate (PC), ethylene vinyl acetate (EVA), polyurethane (PU), and acetyl celluloid.

8. The laminated glazing of claim 1, wherein the first heating circuit is present on at least a first portion of the internal surface of one of either the first glass sheet or the second glass sheet and the second heating circuit is present on at least a second portion of the same glass sheet.

9. The laminated glazing of claim 1, wherein the first heating circuit is present on at least a portion of the internal surface of the first glass sheet, and the second heating circuit is present on at least a portion of the internal surface of the second glass sheet.

10. The laminated glazing of claim 6, wherein the first heating circuit is present on at least the portion of the internal surface of at least one of the first or second glass sheets, and the second heating circuit is present on at least a portion of one of the first or second surfaces of the polymeric substrate.

11. The laminated glazing of claim 6, wherein the first heating circuit is present on at least the portion of the first surface of the polymeric substrate, and the second heating circuit is present on at least the portion of the second surface of the polymeric substrate.

12. The laminated glazing of claim 6, wherein the first heating circuit is present on at least a first portion of the first surface of the polymeric substrate, and the second heating circuit is present on at least a second portion of the first surface of the polymeric substrate.

13. The laminated glazing of claim 1, wherein the first heating circuit and the second heating circuit both comprise the metallic mesh.

14. The laminated glazing of claim 1, wherein the overlap region represents a surface percentage of the total laminated glazing surface comprising:
less than 10% of the total laminated glazing surface, or
10 to 50% of the total laminated glazing surface, or
51 to 90% of the total laminated glazing surface.

15. The laminated glazing of claim 1, further comprising at least one additional glass sheet and at least one additional sheet of interlayer material.

16. The laminated glazing of claim 1, wherein the laminated glazing further comprises at least one other multilayer coating on at least one uncoated surface of any of the glass sheets.

17. The laminated glazing of claim 1, wherein at least one sheet of glass is annealed, thermally treated, strengthened, or chemically tempered.

18. A method for producing a laminated glazing, comprising:
1) providing for
a first and a second glass sheet, each having an internal and external surface;
at least one sheet of adhesive interlayer material serving to bond the internal surfaces of the first and the second glass sheets;
a first heating circuit configured to heat at least a first portion of the laminated glazing; and
a second heating circuit configured to heat at least a second portion of the laminated glazing; and
2) laminating the first and second glass sheets with the at least one sheet of adhesive interlayer material,
wherein the first and second portions at least partially overlap in an overlap region of a total laminated glazing surface.

19. A means of transportation for travel on land, in the air, or on water, comprising the laminated glazing of claim 1.

20. A metallic mesh in a laminated glazing wherein
a distance between two adjacent intersections in the mesh ranges from 0.1 to 500 μm, or
a thickness of the mesh ranges from 1 to 800 nm, or
a conducting path of the mesh ranges from 0.1 to 5 μm, or
a light transmittance on glass of the laminated glazing (at a wavelength of 550 nm) >70%, or
a minimum sheet resistance of the mesh ranges from 0.5 to 10 Ohm/square for a thickness of 300 nm.
